(19) United States
(12) Patent Application Publication
(10) Pub. No.: US 2008/0011417 A1
(43) Pub. Date: Jan. 17, 2008

(54) Compound tooling for controlled work surface characteristics

(76) Inventors: Mark Manuel, Shelby Township, MI (US); Matt Lowney, Davisburg, MI (US); Thomas Greaves, Rochester Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/484,416

(22) Filed: Jul. 11, 2006

(51) Int. Cl. B32B 37/00

(52) U.S. Cl. 156/308.2; 425/470

(57) ABSTRACT

A tool is disclosed for forming an article in a molding operation. The tool includes a first layer with a forming surface for forming the article. The first layer is formed from a first material having a hardness or corrosion resistance sufficient for the forming operation. The second layer is affixed to the first layer for collectively forming a tool body. The second layer is formed from a second material having different material properties than that of the first material, and the second material has sufficient structural integrity for withstanding stresses of the tool body during the forming operation. A tool is also disclosed having a series of laminate sheets collectively providing a portion of the tool body. Another sheet is affixed to the laminate sheets with a homogenous forming surface for forming the article in the molding operation.

### BACKGROUND OF THE INVENTION

1. Field of the Invention

The invention relates to tools for forming articles.

2. Background Art

The prior art provides various tools for forming articles, by various forming processes, such as injection molding, blow molding, reaction injection molding, rotational molding, die casting, stamping and the like. These tools often utilize a first mold half and a second mold half, each having opposing forming surfaces for collectively forming an article therebetween. The mold halves are often formed separately, and one half translates relative to the other for closing, forming the article, opening, removing the article and repeating these steps.

Often, mold halves are each formed from a solid block of material that is capable of withstanding the stresses, pressures, impacts and other fatigues associated with the associated forming processes. The solid block is typically machined to provide the forming surface for the forming operation. Fabricating tools from solid blocks is relatively costly, requires a large volume of material for the solid block, and is labor intensive. Accordingly, the prior art has provided laminate molds or tools, such as that disclosed in U.S. Pat. No. 6,587,742 B2, which issued on Jul. 1, 2003 to Manuel et al.; U.S. Pat. No. 5,031,483, which issued on Jul. 16, 1991 to Weaver; and U.S. Pat. No. 7,021,523 B2, which issued on Apr. 4, 2006 to Manuel; the disclosures of which are incorporated in their entirety by reference herein.

### SUMMARY OF THE INVENTION

A first embodiment of the invention provides a tool for forming an article in a molding operation. The tool includes a first layer having a forming surface for forming the article in the molding operation. The first layer is formed from a first material having a hardness sufficient for the molding operation. A second layer is affixed to the first layer for collectively forming a tool body. The second layer is formed from a second material with a hardness that is less than that of the first material, and the second material has a structural integrity that is sufficient for withstanding stresses of the tool body during a molding operation.

Another embodiment of the present invention provides a tool for forming an article in a molding operation. The tool includes a series of laminate sheets affixed to each other collectively to provide a portion of a tool body. The tool also includes at least another sheet affixed to at least one of the series of laminate sheets for collectively providing the tool body. The at least another sheet has a homogeneous forming surface for forming the article in the molding operation.

A further embodiment of the invention provides a tool for forming an article in a molding operation. The tool includes a first layer having a forming surface for forming the article in the molding operation. The first layer is formed from a first material having a corrosion resistance sufficient for the molding operation. A second layer is affixed to the first layer for collectively forming a tool body. The second layer is formed from a second material having different properties than that of the first material, and the second material has a structural integrity that is sufficient for withstanding stresses of the tool body during a molding operation.

Yet another embodiment of the present invention is a method for providing a tool for forming an article in the molding operation. The method includes providing a first portion of the tool. A forming surface is formed in the first portion of the tool for forming the article in the molding operation. A series of laminate sheets are provided. Each laminate sheet is formed to collectively provide a second portion of the tool. The first portion of the tool is bonded to the series of laminate sheets to thereby form the tool.

The above embodiments, and other embodiments, aspects, objects, features, and advantages of the present invention are readily apparent from the following detailed description of embodiments of the invention when taken in connection with the accompanying drawings.

### BRIEF DESCRIPTION OF THE DRAWINGS

FIG. 1 is a perspective view of a tool in accordance with the present invention;

FIG. 2 is a perspective view of another tool in accordance with the present invention, the tool being utilized in cooperation with the tool of FIG. 1 to collectively form an article in a molding operation;

FIG. 3 is a section view taken along section line 3-3 of the tool of FIG. 2;

FIG. 4 is another section view taken along section line 3-3 of the tool of FIG. 2;

FIG. 5 is yet another section view taken along section line 3-3 of the tool of FIG. 2;

FIG. 6 is an alternative section view taken along section line 3-3 of the tool of FIG. 2; and

FIG. 7 is another alternative section view taken along section line 3-3 of the tool of FIG. 2.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

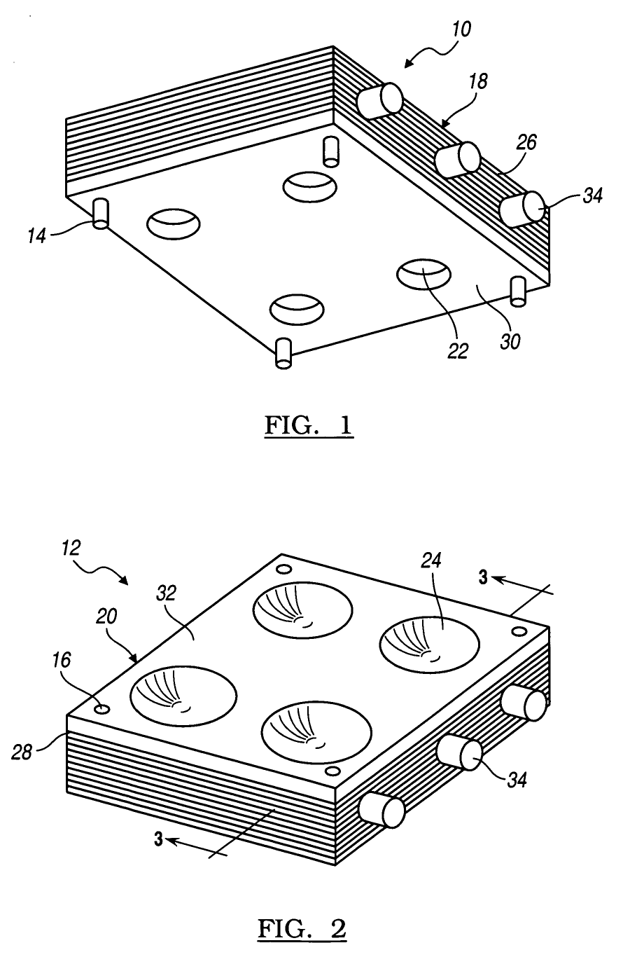

With reference now to FIG. 1, a tool is illustrated in accordance with the present invention and is referenced generally by numeral 10. The tool 10 is a tool for forming an article in a molding operation, such as injection molding, blow molding, reaction injection molding, rotational molding, die casting, stamping or the like. Alternatively, the tool 10 may be a mandril that is shaped similar to the article for forming a tool that is subsequently utilized for forming the article. The tool 10 may be utilized alone for forming an article, or may be utilized in combination with the tool 12 of FIG. 2 for collectively forming an article. Accordingly, the tool 10 of FIG. 1 is a first mold half utilized in cooperation with the tool 12 of FIG. 2, which is a second mold half. The first mold half 10 includes a series of alignment pins 14, which are subsequently mated with corresponding apertures 16 in second mold half 12 for alignment of the mold halves 10, 12 relative one another during the molding operation.

Each mold half 10, 12 includes a tool body 18, 20 with a forming surface 22, 24 for forming the article. For the embodiments illustrated, each mold half 10, 12 includes an array of four forming surfaces 22, 24 for collectively forming four articles in a single molding operation. For the particular embodiment illustrated, the forming surfaces 22, 24 collectively form a polymeric cap that is utilized for plugging apertures in electrical junction boxes. Although one embodiment is illustrated and described, the invention contemplates any number of tools or mold members, and any molded, cast, stamped article or the like in accordance with the spirit and scope of the present invention.

The mold halves 10, 12 are also illustrated with tool bodies 18, 20 that are formed from a series of laminate sheets 26, 28. Laminate mold tooling provides many advantages and benefits over non-laminate mold tooling that is formed from a single block. These advantages include reduction in labor and costs, reduction in material utilized, reduction in tool body inventory requirements, and advantages in manufacturing, heat transfer and the like. Other advantages and benefits of laminate tooling are set forth in the Manuel U.S. Pat. No. 6,587,742 B2 patent; the Weaver U.S. Pat. No. 5,031,483 patent; and the Manuel U.S. Pat. No. 7,021,523 B2 patent; which have been incorporated by reference.

Typically, laminate tools include a forming surface that is provided collectively across a plurality of laminate sheets. However, some forming operations require a homogenous forming surface to provide a uniform surface upon the article formed by the tool. Such articles may include the caps formed by the first and second mold halves 10, 12 of FIGS. 1 and 2, lenses, lamps, or high quality products such as consumer products that simulate the look of a non-molded material (such as a molded door with a faux wood grained surface). Accordingly, the tool bodies 18, 20 are each provided with an additional laminate sheet 30, 32, which provides the forming surface 22, 24 unitarily formed therein by machining or any suitable manufacturing process. The laminate sheet 30, 32 with the forming surface 22, 24 may be provided with a sheet thickness that is greater than the incremental sheet thickness of the laminate sheets 26, 28 of the tool body 18, 20 so that the forming surface 22, 24 may be machined or otherwise formed into the laminate sheet 30, 32. Thus, the benefits of laminate tooling may be utilized in combination with the benefits of block tooling by providing a homogenous forming surface for a uniform grain structure that is recreated in the resulting article formed by the tools 10, 12.

Laminate tooling is not typically used for die casting because a uniform or corrosion resistant forming surface is required in die casting. For example, in laminate tooling with a forming surface formed across a series of laminate sheets, the die cast material, such as aluminum attacks the joints of sequentially bonded laminate sheets thereby damaging the tool and diminishing the quality of the article cast by the tool. Accordingly, by utilizing a tool body 18, 20 having the forming surface 22, 24 formed through a single laminate sheet 30, 32 of the respective tool body 18, 20, the joints of the laminate sheets 26, 30 and 28, 32 are not exposed to the die cast material during the casting operation. Thus, the tools 10, 12 of the present invention utilize the benefits of both solid block molds, by providing homogenous forming surfaces and non-laminate forming surfaces, while employing the benefits of laminate mold tooling for rapid fabrication and controlled and/or conformal heat transfer.

By providing compound laminate tooling for forming operations, various materials may be utilized where required. For example, various forming operations require that the forming surface 22, 24 have an adequate hardness for the forming operation. However, to enhance the conformal and controlled heat transfer within the tool body 18, 20 a different material may be provided for the non-forming laminate sheets 26, 28. Thus, the compound tooling of the present invention provides tooling formed from multiple materials for getting the benefits of a hardened surface for the forming operation and a thermally conductive medium for heating and cooling of the forming surface 22, 24.

For example, tool steel is often utilized for the block of the forming surface for die casting operations. For die casting operations, the forming laminate sheets 30, 32 may be formed from tool steel to provide an adequate hardness or corrosion resistance for the die casting operation. For example, the forming laminate sheets 30, 32 may be formed from American Iron and Steel Institute (AISI) tool steel designation H13, which can be hardened to a high hardness. The remaining layers of the tool body 18, 20 may be formed from a material that does not require the forming surface hardness or corrosion resistance properties, yet has sufficient structural integrity to withstand stresses of the tool body during the molding operation. Thus, the non-forming laminate sheets 26, 28 may be formed from an AISI designation 4130 stainless steel for supporting the forming laminate sheets 30, 32 during the molding operation and providing adequate thermal conductivity for controlled and conformal heat transfer of the forming surfaces 22, 24.

Of course, the invention contemplates various combinations of materials for the multiple layers of the tool body 18, 20 in accordance with the present invention to maximize the quality of the article created by the tool 10, 12 by providing the appropriate material hardness or corrosion resistance for the forming surfaces 22, 24 and the appropriate materials for supporting the forming laminate sheets 30, 32, while providing adequate thermal conductivity to the adjacent laminate sheets 26, 28 for controlling heating and cooling of the forming surfaces 22, 24 and the associated article. Such controlled and conformal heating and cooling may increase the quality of the formed article and reduce defects of the formed article while minimizing cycle time. The desired hardness, structural integrity, and rates of heat transfer may be predetermined by conventional mechanics and heat transfer calculations, finite element analysis, or the like, and these design criteria may be specific for each forming operation.

The tools 10, 12 may be utilized for an injection molding machine for molding a polymeric article. In such applications, a tool steel such as AISI designation S7 may be utilized for the forming laminate sheets 30, 32 to provide the adequate hardness for the forming operation, such as a Rockwell measurement within a range of mid-forties to mid-fifties. The non-forming laminate sheets 26, 28 may be formed from a material that is not as hard as S7, but has a higher coefficient of thermal conductivity, such as aluminum or copper. Thus, the S7 layer would provide the appropriate hardness for the forming surfaces 22, 24, while the aluminum or copper offers an improved rate of heat transfer. For example, S7 tool steel has a coefficient of thermal conductivity of approximately twenty-five to thirty-five W/m*K (Watts per meter*Kelvin), with heat transfer that is greatly improved by utilization of copper for the non-forming laminate sheet, since copper has a coefficient of thermal conductivity of approximately 360 W/m*K.

As stated above various combinations may be utilized in accordance with the teachings of the present invention. For example, for some polymeric molding operations, AISI 4130 stainless steel or P20 tool steel, may be utilized for the forming laminate sheets 30, 32, while utilized in cooperation with an enhanced thermally conductive material for the non-forming laminate sheets 26, 28, such as various copper alloys, various tool steel or stainless steel alloys, or the like, or combinations thereof.

In tooling that is formed from solid blocks of material, large quantities of material and time are employed for hollowing out a back surface of the block for reduced weight, and/or improved heat transfer characteristics. By utilizing the compound tooling of the present invention with layers of various materials, the non-forming laminate sheets may have a density less than that of the forming sheet for reducing the overall weight of the tooling. Additionally, the non-forming laminate sheets may be formed with cavities collectively formed therethrough for reducing weight and/or improving heat transfer characteristics.

Another benefit of the compound material laminate tooling of the present invention, is material costs. Tool steels and other hardened layers which are often required for adequate hardness of the forming surfaces 22, 24 are relatively costly in comparison to other materials. Thus, the costs of the tools 10, 12 may be reduced by utilizing a lower cost material for the non-forming laminate sheets 26, 28 that is adequate for the structural integrity and heat transfer characteristics required for the non-forming laminate sheets 26, 28.

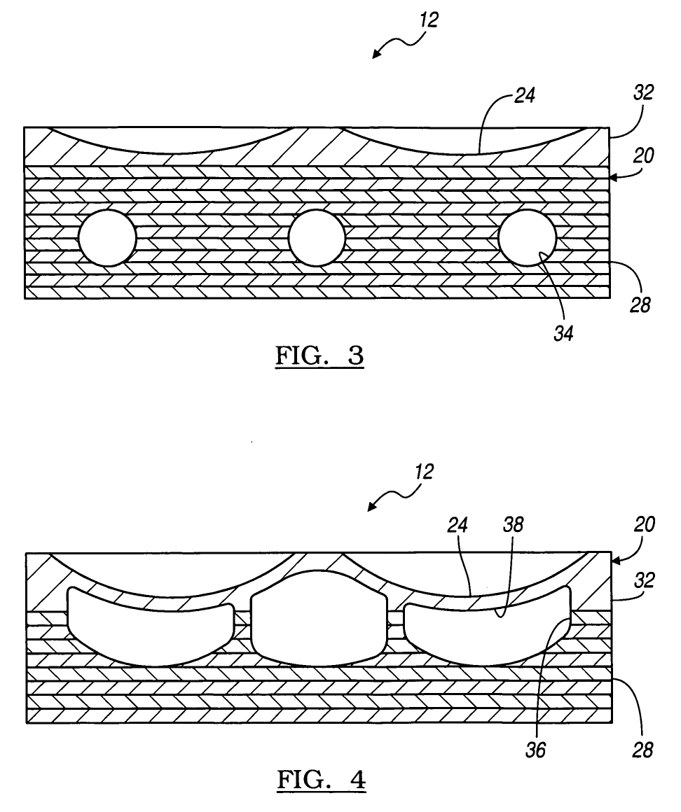

With reference to FIG. 3, the second mold half 12 is illustrated sectioned through the tool body 20. The tool body 20 includes the forming laminate sheet 32 bonded to a series of parallel non-forming laminate sheets 28. The laminate sheets 28, 32 may be affixed by any suitable apparatus or method, such as mechanical fasteners, bonding materials or the like. For example, the laminate sheets 28, 32 may be brazed together by a material having a lower melting temperature such as copper. The non-forming laminate sheets 28 may include ducts 34 formed through the sheets 28 during the fabrication of the non-forming laminate sheets 28 or after the assembly of the tool body 20. The teachings of Weaver U.S. Pat. No. 5,031,483; and Manuel et al. U.S. Pat. No. 6,587,742 B2 disclose methods and tools for providing ducts 34 through the laminate sheets 28 and tool bodies 20. The ducts 34 may be utilized for conveying a fluid through the tool body 20 for heating or cooling the forming surface 24 of the forming laminate sheet 32. The ducts 34 may be arranged linearly or non-linearly in a pattern that may conform to the shape of the forming surface 24 for controlled heating and cooling of the forming surface 24.

With reference now to FIG. 4, another cross section of the second mold half 12 is illustrated in accordance with the present invention. The mold 12 is provided with heat transfer chambers such as conformal cooling ducts 36 provided collectively by the non-forming laminate sheets 28 and the forming laminate sheet 32. The conformal cooling ducts 36 are conformed to the geometry of the forming surface 24 for uniform and controlled heating and cooling of the forming surface 24 by fluid that is pumped through the ducts 36. The ducts 36 may be formed within the non-forming laminate sheets 28 by the teachings disclosed in U.S. Patent Application Publication No. 2004/0103709 A1, which published on Jun. 3, 2004 to Manuel et al., the disclosure of which is incorporated in its entirety by reference herein. A portion 38 of the ducts 36 may be formed in a back surface of the forming laminate sheet 32. The duct portion 38 may be machined into the back surface prior to assembly of the tool body 20.

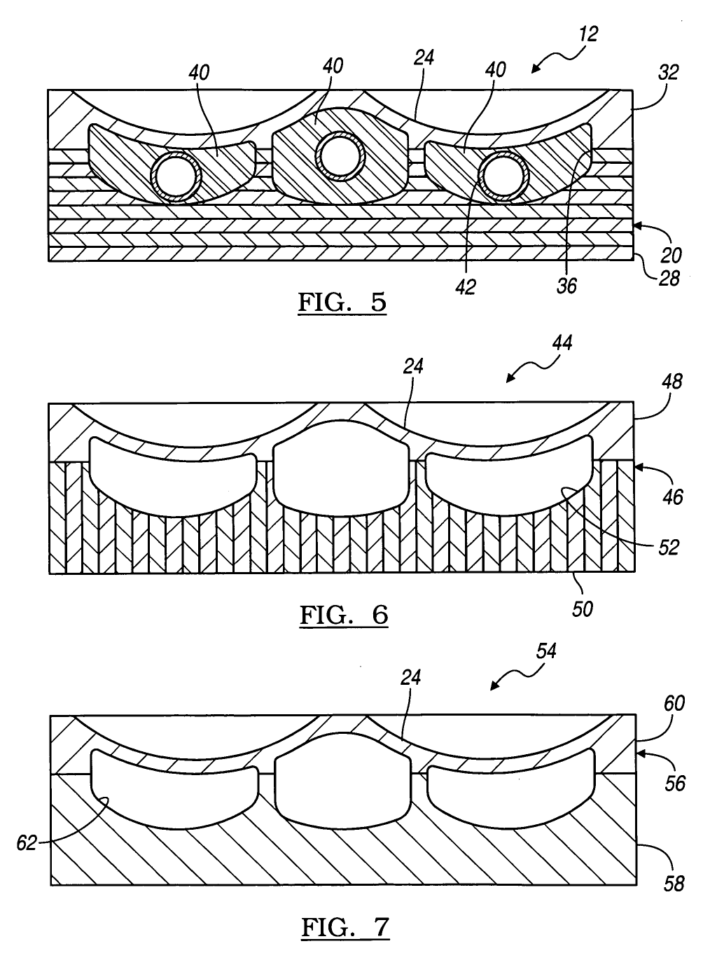

With reference now to FIG. 5, another section of the second mold half 12 is illustrated in accordance with the present invention. Similar to the embodiment of FIG. 4, the tool body 20 is illustrated with heat transfer chambers 36 formed collectively by the series of non-forming laminate sheets 28 and the forming laminate sheet 32. The chambers 36 are illustrated with a heat sink material 40 disposed therein. The heat sink material 40 may be provided of a material having a coefficient of thermal conductivity greater than that of the non-forming laminate sheets 28 and the forming laminate sheet 32 to enhance the dissipation of heat from the forming surface 24 to the heat sink material 40 or the reverse. Additionally, tubular fluid lines 42 may be provided within the chambers 36 for transferring fluid through the tool body 20 within the chambers 36. Thus, a heated fluid may be pumped through the fluid lines 42 for accelerated transfer of heat to the forming surface 24 due to the highly conductive heat sink material 40. Likewise, a coolant may be pumped through the fluid lines 42 to dissipate heat from the forming surface 24 to the coolant within the fluid lines 42. The fluid lines 42 may be disposed within the chambers 36 during assembly and the heat sink material 40 may be cast into the tool body 20. These methods and tools fabricated by these methods are disclosed in U.S. application Ser. No. 11/037,615 filed on Jan. 18, 2005 by Manuel; U.S. application Ser. No. 11/233,708 filed on Sep. 23, 2005 by Manuel et al; and U.S. application Ser. No. ______, filed on ______ by Manuel et al., titled Compound Mold Tooling For Controlled Heat Transfer.

Referring now to FIG. 6, an alternative embodiment tool 44 is illustrated in accordance with the present invention. The tool 44 is similar to the tool 12 of prior embodiments, with a tool body 46 provided by a forming laminate sheet 48 secured to a series of non-forming laminate sheets 50. Unlike the prior embodiments, the non-forming laminate sheets 50 are oriented generally perpendicular to the forming laminate sheet 48. Accordingly, any orientation or combinations of orientations of non-forming laminate sheets 50 are contemplated for forming a tool body 46 within the spirit and scope of the present invention. The non-forming laminate sheets 50 may be provided with thermal management characteristics, such as conformal chambers 52 formed therethrough collectively with the forming laminate sheet 48.

The invention contemplates any number of forming laminate sheets and non-forming laminate sheets in accordance with the present invention. Referring now to FIG. 7, a section view is illustrated of an alternative embodiment of a tool 54 in accordance with the present invention. The tool 54 has a tool body 56 provided by a single non-forming laminate sheet 58 bonded to a single forming laminate sheet 60. Unlike the prior embodiments however, the tool 54 may require machining to the non-forming laminate sheet 58 in order to provide thermal management characteristics, such as chambers 62 formed therethrough.

In summary, the present invention combines the advantages and benefits of both block mold tooling and laminate sheet tooling into a common tool or method for making the tool for increasing the advantages, benefits and flexibility of mold tooling while reducing the costs, weight and labor required to fabricate the tooling.

The tooling for forming the article may be fabricated by: providing a first portion of the tool, such as the forming laminate sheet 32 of the second mold half 12 of FIGS. 2 and 3. The forming surface 24 may then be machined into the laminate sheet 32. Subsequently, a series of non-forming laminate sheets 28 may be provided which may be of another material. The non-forming laminate sheets 28 may each be cut individually as disclosed in the Manuel U.S. Pat. No. 6,587,742 B2; and the Weaver U.S. Pat. No. 5,031,483 patent, to provide corresponding structure and thermal management properties such as ducts, chambers, fluid lines, heat sinks or the like. Subsequently, the forming laminate sheet 32 and non-forming laminate sheets 28 are bonded together utilizing a suitable method thereby providing the tool body 20.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tool for forming an article in a molding operation comprising:
a first layer having a forming surface for forming the article in the molding operation, the first layer being formed from a first material having a hardness sufficient for the molding operation; and
a second layer affixed to the first layer for collectively forming a tool body and not forming part of the article forming surface, the second layer being formed from a second material having a hardness less than that of the first material and the second material having a structural integrity sufficient for withstanding stresses of the tool body during the molding operation.

2. The tool of claim 1 wherein the first layer provides a homogeneous forming surface for forming the article.

3. The tool of claim 1 wherein the second layer further comprises a series of laminate sheets.

4. The tool of claim 1 wherein the first layer is formed from a tool steel.

5. The tool of claim 1 wherein the second layer is formed from aluminum.

6. The tool of claim 1 wherein the second layer is formed from stainless steel.

7. The tool of claim 1 wherein the second layer is formed from a material having a coefficient of thermal conductivity greater than that of the first layer.

8. The tool of claim 1 wherein the first layer and second layer collectively provide a heat transfer chamber for conveying a heat transfer fluid through the tool during the molding operation.

9. The tool of claim 1 wherein the second layer has a material density less than that of the first material.

10. The tool of claim 1 wherein the first layer and second layer are connected by a bonding material.

11. The tool of claim 10 wherein the bonding material is brazed into the tool.

12. A tool for forming an article in a molding operation comprising:
a series of laminate sheets affixed to each other collectively providing a portion of a tool body that is not in contact with the article to be formed; and
at least another sheet affixed to at least one of the series of laminate sheets for collectively forming the tool body, the at least another sheet having a homogeneous forming surface formed therein for forming the article in the molding operation.

13. The tool of claim 12 wherein the at least another sheet is oriented generally parallel with the series of laminate sheets.

14. The tool of claim 12 wherein the at least another sheet is oriented generally perpendicular to the series of laminate sheets.

15. A tool for forming an article in a molding operation comprising:
a first layer having a forming surface for forming the article in the molding operation, the first layer being formed from a first material having a hardness and a corrosion resistance sufficient for the molding operation; and
a second layer affixed to the first layer for collectively forming a tool body, the second layer being formed from a second material having different properties than that of the first material and the second material having a structural integrity sufficient for withstanding stresses of the tool body during the molding operation, the second layer not forming part of the article forming surface.

16. The tool of claim 16 wherein the second layer is softer than the first layer.

17. The tool of claim 16 wherein the second layer is less corrosion resistant than the first layer.

18. The tool of claim 16 wherein the second layer is provided with at least one cooling chamber formed therethrough with a heat sink material disposed within the at least one cooling chamber.

19. The tool of claim 18 further comprising at least one cooling line disposed within the at least one cooling chamber in contact with the heat sink material for conveying coolant through the at least one cooling line.

20. A method for providing a tool for forming an article in a molding operation comprising:
providing a first portion of the tool;
forming a forming surface into the first portion of the tool for forming the article in the molding operation;
providing a series of laminate sheets;
forming each sheet to collectively provide a second portion of the tool; and
bonding the first portion of the tool to the series of laminate sheets to thereby form the tool.

21. The method of claim 20 further comprising:
providing the first portion of the tool from a material having a material hardness; and
providing the series of laminate sheets from another material having a material hardness less than that of the first portion of the tool.

22. The method of claim 20 further comprising machining the forming surface into the first portion of the tool.

23. The method of claim 20 further comprising:
providing a bonding material having a melting temperature less than that of the first portion and the series of laminate sheets, in contact with the tool;
heating the tool to a temperature greater than that of the melting temperature of the bonding material such that the bonding material is brazed into the tool; and
cooling the tool so that the bonding material bonds the first portion of the tool and the series of laminate sheets.

24. The method of claim 20 further comprising forming a heat transfer chamber collectively through the series of laminate sheets for conveying a heat transfer fluid through the tool during the molding operation.

25. The method of claim 20 further comprising forming a heat transfer chamber collectively through the first portion of the tool and the series of laminate sheets, for conveying a heat transfer fluid through the tool during the molding operation.

26. The method of claim 25 further comprising inserting a fluid line within the heat transfer chamber.

27. The method of claim 26 further comprising filling the remainder of the heat transfer chamber with a heat sink material in contact with the fluid line.
